(19) United States
(12) Patent Application Publication
(10) Pub. No.: US 2020/0135194 A1
(43) Pub. Date: Apr. 30, 2020

(54) ELECTRONIC DEVICE

(71) Applicant: LG ELECTRONICS INC., Seoul (KR)

(72) Inventor: Gyuhyeok JEONG, Seoul (KR)

(73) Assignee: LG ELECTRONICS INC., Seoul (KR)

(21) Appl. No.: 16/607,707

(22) PCT Filed: Jul. 5, 2017
(86) PCT No.: PCT/KR2017/007125

§ 371 Date: Oct. 23, 2019

(30) Foreign Application Priority Data
Apr. 24, 2017 (KR) 10-2017-0052567

(51) Int. Cl. G10L 15/22; G10L 17/12; G10L 15/20; G10L 15/16

(52) U.S. Cl. CPC G10L 15/22; G10L 17/12; G10L 2015/223; G10L 15/16; G10L 2015/221; G10L 15/20

(57) ABSTRACT

Disclosed herein is an electronic device. The electronic device according to an embodiment of the present disclosure includes an input unit configured to receive a speech input including a wakeup word and a command word from a sound source, a communication unit configured to communicate with one or more other electronic devices, an artificial intelligence unit configured to obtain a degree of recognition of the wakeup word in the electronic device, receive a degree of recognition of the wakeup word in each of the one or more other electronic devices, and perform a function corresponding to the command word when the electronic device has a highest priority based on the degree of recognition of the wakeup word in the electronic device and the degree of recognition of the wakeup word in each of the one or more other electronic devices, wherein the degree of recognition of the wakeup word in the electronic device is obtained based on at least one of a score of the wakeup word or location information of the sound source, in the electronic device.

### TECHNICAL FIELD

The present disclosure relates to an electronic device capable of determining whether to perform a command when the same wakeup word is input to a plurality of electronic devices.

### BACKGROUND ART

Artificial intelligence is a field of computer engineering and information technology that research a method for allowing computers to do thinking, learning, self-development or the like that can be done by human intelligence, and means that computers is allowed to imitate human intelligent behavior.

In addition, the artificial intelligence does not exist by itself, but is directly or indirectly related to other fields of computer science. Especially, artificial intelligent factors has been introduced in the various field of information technology, and it has been actively attempted to utilize them to solve problems in the field.

On the other hand, conventionally, the context awareness technology for recognizing a user's situation using artificial intelligence and providing information or a function desired by the user in a desired form has been actively studied.

As the context awareness technology described above has been developed, demand for electronic devices capable of performing functions appropriate to a user's situation is increasing. On the other hand, by combining the technology of recognizing the user's speech and the context awareness technology, electronic devices that perform various operations and functions to the user through speech recognition is increasing.

A wakeup word refers to a word for calling an electronic device. When he user first inputs the wakeup word to call the electronic device and then inputs a command word, the electronic device performs a function corresponding to the command word.

On the other hand, when a plurality of electronic devices use the same speech recognition engine, a word for calling a plurality of electronic devices may be forced to the same wakeup word.

Accordingly, when a user says a wakeup word in a state where a plurality of electronic devices are located in one place such as a house, a problem may occur that the plurality of electronic devices are simultaneously called.

In this case, there may be an electronic device that does not recognize a word command following the wakeup word, which may cause inconvenience to a user.

For example, when a wakeup word of “Michael” is input, an air conditioner and a speaker in a house may be called at the same time. Thereafter, when a command word of “Play the music” is input after the input of the wakeup word, the speaker may perform a function corresponding to the command word of “Play the music” (that is, a function of playing back music), but the air conditioner may output a message of “I can't understand” because the air conditioner is not able to perform a function corresponding to the command of “Play the music”.

In addition, a plurality of electronic devices may recognize a command word following the wakeup word, causing inconvenience to users.

For example, when a user inputs a speech of “Michael, lower the temperature” to lower the temperature of the refrigerator, the refrigerator may recognize a command word and lower the temperature of the refrigerator. However, it may cause a problem of operating to lower the room temperature by recognizing the command up to the air conditioner.

### DISCLOSURE

### Technical Problem

The present disclosure is to solve the above-described problem, an object of the present disclosure is to provide an electronic device that can determine whether or not to perform the command, when the same wakeup word is input to a plurality of electronic devices.

### Technical Solution

According to an embodiment of the present disclosure, an electronic device includes an input unit configured to receive a speech input including a wakeup word and a command word from a sound source, a communication unit configured to communicate with one or more other electronic devices, an artificial intelligence unit configured to obtain a degree of recognition of the wakeup word in the electronic device, receive a degree of recognition of the wakeup word in each of the one or more other electronic devices, and perform a function corresponding to the command word when the electronic device has a highest priority based on the degree of recognition of the wakeup word in the electronic device and the degree of recognition of the wakeup word in each of the one or more other electronic devices, wherein the degree of recognition of the wakeup word in the electronic device is obtained based on at least one of a score of the wakeup word or location information of the sound source, in the electronic device.

Further, according to another embodiment of the present disclosure, an electronic device includes an input unit configured to receive a speech input including a wakeup word and a speech input including a command word from a sound source, a communication unit configured to communicate with one or more other electronic devices and a server, and an artificial intelligence unit configured to obtain a degree of recognition of the wakeup word in the electronic device, receive a degree of recognition of the wakeup word in each of the one or more other electronic devices, and transmit command word information corresponding to the speech input including the command word to the server when the electronic device has a priority higher than or equal to a predetermined priority based on the degree of recognition of the wakeup word in the electronic device and the degree of recognition of the wakeup word in each of the one or more other electronic devices, wherein the degree of recognition of the wakeup word in the electronic device is obtained based on at least one of a score of the wakeup word or location information of the sound source in the electronic device.

Further, according to an embodiment of the present disclosure, a server includes a communication unit configured to communicate with a plurality of electronic devices, and a control unit configured to receive command word information corresponding to a speech input of a user from one or more electronic devices, recognize a command word included in the speech input based on the command word information, obtain a function corresponding to the command word and transmit a command for performing the function corresponding to the command word to one of the one or more electronic devices.

### Advantageous Effects

The present disclosure may prevent confusion that may occur when the plurality of electronic devices are forced to use the same wakeup word.

### DESCRIPTION OF DRAWINGS

FIG. 1 is a diagram illustrating a plurality of electronic devices according to an embodiment of the present disclosure.

FIG. 2 is a block diagram illustrating an electronic device according to an embodiment of the present disclosure.

FIG. 3 is a block diagram illustrating a configuration of the display 100 as an example of an electronic device.

FIG. 4 is a diagram illustrating a use environment of a plurality of electronic devices according to an embodiment of the present disclosure.

FIG. 5 is a diagram for describing a method of operating an electronic device according to an embodiment of the present disclosure.

FIG. 6 is a diagram illustrating a plurality of electronic devices and a server according to another embodiment of the present disclosure.

FIG. 7 is a diagram for describing a server according to an embodiment of the present disclosure.

FIG. 8 is a diagram for describing an operating method of an electronic device and a server according to a fourth embodiment of the present disclosure.

FIG. 9 is a diagram for describing a method of operating an electronic device and a server according to a fifth embodiment of the present disclosure.

FIG. 10 is a diagram for describing a method of operating an electronic device and a server according to a sixth embodiment of the present disclosure.

### MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

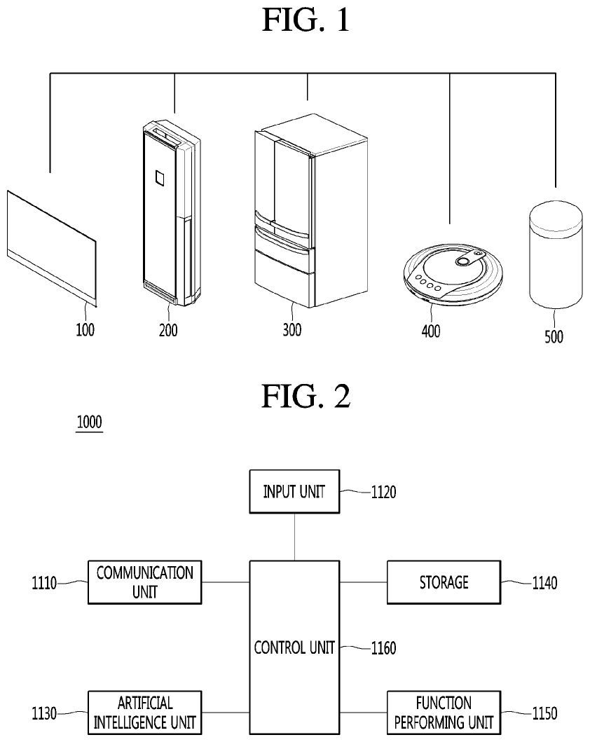

FIG. 1 is a diagram illustrating a plurality of electronic devices according to an embodiment of the present disclosure.

A plurality of electronic devices 100, 200, 300, 400 and 500 may communicate with one another.

In more detail, each of the plurality of electronic devices may include a communication unit, and the communication unit may provide an interface for connecting the electronic device to a wired/wireless network including an Internet network. The communication unit may transmit or receive data to or from another electronic device through the connected network or another network linked to the connected network.

In addition, the communication unit may support short range communication using at least one of Bluetooth [symbol] , Radio Frequency Identification (RFID), Infrared Data Association (IrDA), Ultra Wideband (UWB), ZigBee, Near Field Communication (NFC), Wi-Fi (Wireless-Fidelity), Wi-Fi (Wireless-Fidelity), Wi-Fi Direct, and Wireless USB (Wireless Universal Serial Bus) technologies.

The communication unit may support wireless communication between the electronic device and another electronic device through short-range wireless area networks.

The plurality of electronic devices 100, 200, 300, 400, and 500 may be devices located within a specific range. Accordingly, at least two or more electronic devices of the plurality of electronic devices may receive and recognize the same speech of a user.

In addition, the plurality of electronic devices 100, 200, 300, 400, and 500 may be electronic devices located together in a specific place. For example, the plurality of electronic devices 100, 200, 300, 400, and 500 may be a TV, an air conditioner, a refrigerator, a cleaner, or a speaker installed in one house. In this case, at least two or more electronic devices among the plurality of electronic devices may receive and recognize the same speech of the user.

A speech recognition engine may be mounted on each of the plurality of electronic devices 100, 200, 300, 400, and 500. Here, the speech recognition engine may include a keyword engine that recognizes a wakeup word and a continuous speech engine that recognizes a general command for performing a function.

The same speech recognition engine may be mounted on each of the plurality of electronic devices 100, 200, 300, 400, and 500.

Meanwhile, the plurality of electronic devices 100, 200, 300, 400, and 500 may be called by, for example, a wakeup word.

Herein, the meaning that the electronic device is called may mean that the electronic device enters a command waiting state. The command waiting state may refer to a state in which when a speech input is received, a command word included in speech input is able to be recognized by processing the received speech input using the continuous speech engine.

Specifically, each of the plurality of electronic devices 100, 200, 300, 400 and 500 operates normally in a call waiting state. When the speech input of the user is received in the call waiting state, each of the plurality of electronic devices 100, 200, 300, 400, and 500 may determine whether a wakeup word is included in the speech input of the user by processing the speech input using the keyword engine. Each of the plurality of electronic devices 100, 200, 300, 400, and 500 may operate in a command waiting state when the wakeup word is included in the speech input of the user and remains in the call waiting state when the speech input of the user does not include the wakeup word.

For example, when a user speaks a wakeup word “Michael”, each of the plurality of electronic devices 100, 200, 300, 400, and 500 may receive a speech input including the wakeup word “Michael” and determine that the speech input includes the wakeup word “Michael” through the recognition of the speech input. Accordingly, each of the plurality of electronic devices 100, 200, 300, 400, and 500 may enter a command waiting state.

Meanwhile, the plurality of electronic devices 100, 200, 300, 400, and 500 may be called by the same wakeup word. For example, the wakeup word calling a first electronic device 100 may be “Michael”, and the wakeup word calling a second electronic device 200 may also be “Michael”.

FIG. 2 is a block diagram illustrating an electronic device according to an embodiment of the present disclosure.

In FIG. 1, a TV, an air conditioner, a refrigerator, a cleaner, and a speaker are illustrated, which may be an example of an electronic device 1000. That is, the electronic device 1000 described in the present disclosure may include all electronic devices that recognize a user's speech and perform a device-specific function based on the user's speech.

The electronic device 1000 according to an embodiment of the present disclosure may include a communication unit 1110, an input unit 1120, an artificial intelligence unit 1130, a storage unit 140, a function performing unit 1150, and a control unit 1160.

The communication unit 1110 may provide an interface for connecting the electronic device 1000 to a wired/wireless network including an Internet network. The communication unit 1110 may transmit or receive data to or from another electronic device through the connected network or another network linked to the connected network.

In addition, the communication unit 1110 may support short range communication using at least one of Bluetooth [symbol] , Radio Frequency Identification (RFID), Infrared Data Association (IrDA), Ultra Wideband (UWB), ZigBee, Near Field Communication (NFC), Wi-Fi (Wireless-Fidelity), Wi-Fi (Wireless-Fidelity), Wi-Fi Direct, and Wireless USB (Wireless Universal Serial Bus) technologies.

The communication unit 1110 may support wireless communication between the electronic device and another electronic device through short-range wireless area networks.

The communication unit 1110 may communicate with one or more other electronic devices.

The input unit 1120 may process an external sound signal so as to generate electrical speech data. To this end, the input unit 1120 may include one or more microphones.

The processed speech data may be utilized in various ways according to a function (or a running application program) being performed in the electronic device 1000. Meanwhile, various noise reduction algorithms may be implemented in the input unit 1120 to remove noise occurring in the process of receiving an external sound signal.

The input unit 1120 may receive the user's speech input and other sounds.

The artificial intelligence unit 1130 may process information based on artificial intelligence technology, and include one or more modules that perform at least one of learning information, inferring information, perceiving information, and processing natural language.

The artificial intelligence unit 1130 may perform at least one of learning, inferring, and processing a large amount of information (big data), such as information stored in an electronic device, surrounding environment information of the electronic device, and information stored in an external storage capable of communicating therewith, using machine learning technology. The artificial intelligence unit 1130 may predict (or infer) an operation of at least one executable electronic device using information learned using the machine learning technology, and control the electronic device such that the most practicable operation of the at least one predicted operations is performed.

Machine learning technology is a technology that collects and learns a large amount of information based on at least one algorithm, and determines and predicts information based on the learned information. The learning of information is an operation of quantifying a relationship between pieces of information by grasping characteristics, rules, judgment criteria, or the like for the pieces of information, and predicting new data using a quantized pattern.

The algorithms used by the machine learning technology may be algorithms based on statistics, and may include for example, decision trees that use tree structures as predictive models, artificial neural networks that mimic the neural network structure and functions of living things, genetic programming based on evolutionary algorithms of living things, clustering that distributes observed examples into subsets that is clusters, and the Monte Carlo method for calculating function values with probability using randomly extracted random numbers.

As a field of machine learning technology, deep learning technology is a technology that performs at least one of learning, determining, and processing information by using an artificial neural network algorithm. The artificial neural network may have a structure that connects layers to layers and transfers data between layers. Such deep learning technology may learn a huge amount of information through the artificial neural network using a graphic processing unit (GPU) optimized for parallel computation.

Meanwhile, the artificial intelligence unit 1130 may collect (sense, monitor, extract, detect, and receive) signals, data, information, or the like that is inputted or outputted from components of the electronic device to collect a huge amount of information for applying the machine learning technology. In addition, the artificial intelligence unit 130 may collect (sense, monitor, extract, detect, and receive) data, information, and the like stored in an external storage (for example, a cloud server) connected through communication. More specifically, the collection of information may be understood as a term including an operation of sensing information through a sensor, extracting information stored in the storage unit 1140, or receiving information from the external storage through communication.

The artificial intelligence unit 1130 may detect information in the electronic device, surrounding environment information of a mobile terminal, and user information through the input unit 1120 or various sensing units (not shown). Also, the artificial intelligence unit 1130 may receive a broadcast signal and/or broadcast-related information, a wireless signal, wireless data, and the like through the communication unit 1110. In addition, the artificial intelligence unit 130 may receive image information (or signals), audio information (or signals), data from the input unit, or information inputted from the user.

The artificial intelligence unit 130 may collect and learn a large amount of information in real time in background and store the information (e.g., knowledge graph, command word policy, personalized database, conversation engine, or the like) processed in an appropriate form, in the storage unit 1140.

When an operation of the electronic device is predicted based on the information learned using the machine learning technology, the artificial intelligence unit 1130 may control components of the electronic device or transmit a control command for executing the predicted operation to the control unit 1160 to execute the predicted operation. The control unit 1160 may execute the predicted operation by controlling the electronic device based on the control command.

Meanwhile, when a specific operation is performed, the artificial intelligence unit 1130 may analyze history information representing performance of the specific operation through machine learning technology, and perform update of previously-learned information based on the analyzed information. Thus, the artificial intelligence unit 1130 may improve accuracy of information prediction.

Meanwhile, the artificial intelligence unit 1130 may execute a speech recognition function. In detail, the artificial intelligence unit 1130 may extract language information included in a speech signal received through the input unit 1120, and change the extracted language information into text information.

In addition, the artificial intelligence unit 1130 may execute a speech understanding function. In detail, the artificial intelligence unit 1130 may figure out syntax structure of the text information or the like and determine language information which the text information represents.

Meanwhile, in the present specification, the artificial intelligence unit 1130 and the control unit 1160 may be understood as the same component. In this case, a function executed by the control unit 1160 described herein may be expressed as being executed by the artificial intelligence unit 1130. The control unit 1160 may be referred to as the artificial intelligence unit 1130 and on the other hand, the intelligent unit 1130 may be referred to as the control unit 1160. In addition, all functions of the artificial intelligence unit 1130 and the control unit 1160 disclosed in the present specification may be executed by the artificial intelligence unit 1130 or may be executed by the control unit 1160.

Alternatively, in the present specification, the artificial intelligence unit 1130 and the control unit 1160 may be understood as individual components. In this case, the artificial intelligence unit 1130 and the control unit 1160 may perform various controls on a mobile terminal through data exchange. The control unit 1160 may perform at least one function on the mobile terminal or control at least one of the components of the mobile terminal based on a result derived by the artificial intelligence unit 1130. In addition, the artificial intelligence unit 1130 may also be operated under the control of the control unit 1160.

The storage unit 1140 may store data supporting various functions of the electronic device 1000. The storage unit 1140 may store a plurality of application programs (or applications) that are driven by the electronic device 1000, operations and command words of the electronic device 1000, and data for operations of the artificial intelligence unit 130 (e.g., information on at least one algorithm for machine learning). At least some of these application programs may be downloaded from an external server through wireless communication. In addition, at least some of these application programs may exist on the electronic device 1000 from the time of shipment for basic functions of the electronic device 1000 (for example, a call forwarding, a calling function, and a message receiving and transmitting function). The application programs may be stored in the storage unit 1140 and installed on the electronic device 1000, and may be driven by the control unit 1160 to execute an operation (or a function) of a mobile terminal.

In addition, the storage unit 1140 may store data or an application program for speech recognition and driving of a keyword engine and a continuous speech engine, and may be driven by the artificial intelligence unit 1130 to perform a speech recognition operation.

In addition to the operation related to the application program, the control unit 1160 may typically control the overall operation of the electronic device 1000. The control unit 1160 may provide or process information or a function appropriate to a user by processing signals, data, information, and the like, which are input or output through the above-described components, or by running an application program stored in the storage unit 1140.

In addition, the processor 180 may control at least some of the components described with reference to FIG. 1 in order to run an application program stored in the memory 170. Furthermore, the control unit 1140 may operate at least two or more of the components included in the electronic device 1000 in combination with each other to run the application program.

The function performing unit 1150 may perform an operation in accord with the use purpose of the electronic device 1000 under the control of the control unit 1160 or the artificial intelligence unit 1130.

For example, when the electronic device 1000 is a TV, the electronic device 1000 may perform an operation such as an operation of displaying an image or an operation of outputting sound. In addition, under the control of the artificial intelligence unit 1130 or the control unit 1160, an operation such as turning-on, turning-off, channel switching, or volume change may be performed.

For another example, when the electronic device 1000 is an air conditioner, an operation such as cooling, dehumidification, or air cleaning may be performed. In addition, under the control of the artificial intelligence unit 1130 or the control unit 1160, an operation such as turning-on, turning-off, temperature change, mode change, or the like may be performed.

The function performing unit 1150 may perform a function corresponding to a command word under the control of the control unit 1160 or the artificial intelligence unit 1130. For example, when the electronic device 1000 is a TV and the command word is “Turn off”, the function performing unit 1150 may turn off the TV. In another example, when the electronic device 1000 is an air conditioner and the command is “make it cooler”, the function performing unit 1150 may increase the air volume of discharged air or decrease a temperature.

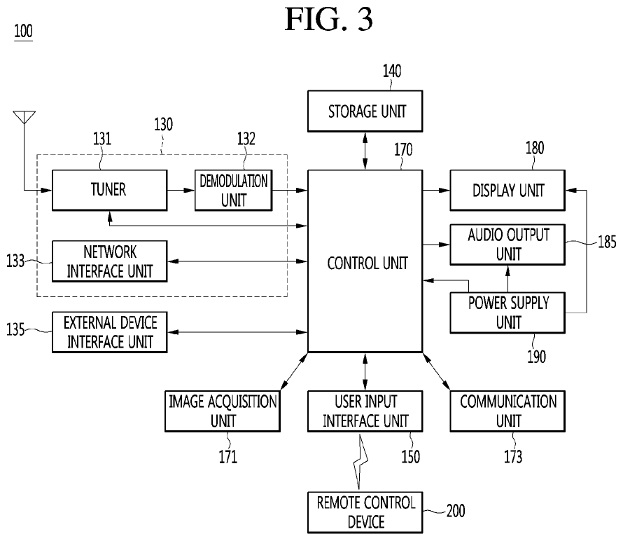

In FIG. 3, the display 100 will be described as an example of the electronic device 1000.

FIG. 3 is a block diagram illustrating a configuration of the display 100 as an example of an electronic device.

A display device (100) according to an embodiment of the present invention, for example, as an artificial display device that adds a computer supporting function to a broadcast receiving function, can have an easy-to-use interface such as a writing input device, a touch screen, or a spatial remote control unit as an internet function is added while fulfilling the broadcast receiving function. Then, with the support of a wired or wireless internet function, it is possible to perform an e-mail, web browsing, banking, or game function in access to internet and computers. In order for such various functions, standardized general purpose OS can be used.

Accordingly, since various applications are freely added or deleted on a general purpose OS kernel, a display device described in this present invention, for example, can perform various user-friendly functions. The display device, in more detail, can be network TV, HBBTV, smart TV, LED TV, OLED TV, and so on and in some cases, can be applied to a smartphone.

FIG. 3 is a block diagram illustrating a configuration of a display device according to an embodiment of the present invention.

Referring to FIG. 3, a display device 100 can include a broadcast reception unit 130, an external device interface unit 135, a storage unit 140, a user input interface unit 150, a control unit 170, a wireless communication unit 173, a display unit 180, an audio output unit 185, and a power supply unit 190.

The broadcast reception unit 130 can include a tuner 131, a demodulation unit 132, and a network interface unit 133.

The tuner 131 can select a specific broadcast channel according to a channel selection command. The tuner 131 can receive broadcast signals for the selected specific broadcast channel.

The demodulation unit 132 can divide the received broadcast signals into video signals, audio signals, and broadcast program related data signals and restore the divided video signals, audio signals, and data signals to an output available form.

The external device interface unit 135 can receive an application or an application list in an adjacent external device and deliver it to the control unit 170 or the storage unit 140.

The external device interface 135 can provide a connection path between the display device 100 and an external device. The external device interface 135 can receive at least one of image and audio output from an external device that is wirelessly or wiredly connected to the display device 100 and deliver it to the control unit. The external device interface unit 135 can include a plurality of external input terminals. The plurality of external input terminals can include an RGB terminal, at least one High Definition Multimedia Interface (HDMI) terminal, and a component terminal.

An image signal of an external device inputted through the external device interface unit 135 can be output through the display unit 180. A sound signal of an external device inputted through the external device interface unit 135 can be output through the audio output unit 185.

An external device connectable to the external device interface unit 130 can be one of a set-top box, a Blu-ray player, a DVD player, a game console, a sound bar, a smartphone, a PC, a USB Memory, and a home theater system but this is just exemplary.

The network interface unit 133 can provide an interface for connecting the display device 100 to a wired/wireless network including internet network. The network interface unit 133 can transmit or receive data to or from another user or another electronic device through an accessed network or another network linked to the accessed network.

Additionally, some content data stored in the display device 100 can be transmitted to a user or an electronic device, which is selected from other users or other electronic devices pre-registered in the display device 100.

The network interface unit 133 can access a predetermined webpage through an accessed network or another network linked to the accessed network. That is, it can transmit or receive data to or from a corresponding server by accessing a predetermined webpage through network.

Then, the network interface unit 133 can receive contents or data provided from a content provider or a network operator. That is, the network interface unit 133 can receive contents such as movies, advertisements, games, VODs, and broadcast signals, which are provided from a content provider or a network provider, through network and information relating thereto.

Additionally, the network interface unit 133 can receive firmware update information and update files provided from a network operator and transmit data to an internet or content provider or a network operator.

The network interface unit 133 can select and receive a desired application among applications open to the air, through network.

The storage unit 140 can store signal-processed image, voice, or data signals stored by a program in order for each signal processing and control in the control unit 170.

Additionally, the storage unit 140 can perform a function for temporarily store image, voice, or data signals output from the external device interface unit 135 or the network interface unit 133 and can store information on a predetermined image through a channel memory function.

The storage unit 140 can store an application or an application list inputted from the external device interface unit 135 or the network interface unit 133.

The display device 100 can play content files (for example, video files, still image files, music files, document files, application files, and so on) stored in the storage unit 140 and provide them to a user.

The user input interface unit 150 can deliver signals inputted from a user to the control unit 170 or deliver signals from the control unit 170 to a user. For example, the user input interface unit 150 can receive or process control signals such as power on/off, channel selection, and screen setting from the remote control device 200 or transmit control signals from the control unit 170 to the remote control device 200 according to various communication methods such as Bluetooth, Ultra Wideband (WB), ZigBee, Radio Frequency (RF), and IR.

Additionally, the user input interface unit 150 can deliver, to the control unit 170, control signals inputted from local keys (not shown) such as a power key, a channel key, a volume key, and a setting key.

Image signals that are image-processed in the control unit 170 can be inputted to the display unit 180 and displayed as an image corresponding to corresponding image signals. Additionally, image signals that are image-processed in the control unit 170 can be inputted to an external output device through the external device interface unit 135.

Voice signals processed in the control unit 170 can be output to the audio output unit 185. Additionally, voice signals processed in the control unit 170 can be inputted to an external output device through the external device interface unit 135.

Besides that, the control module 170 can control overall operations in the display device 100.

Additionally, the control unit 170 can control the display device 100 by a user command or internal program inputted through the user input interface unit 150 and download a desired application or application list into the display device 100 in access to network.

The control unit 170 can output channel information selected by a user together with processed image or voice signals through the display unit 180 or the audio output unit 185.

Additionally, according to an external device image playback command received through the user input interface unit 150, the control unit 170 can output image signals or voice signals of an external device such as a camera or a camcorder, which are inputted through the external device interface unit 135, through the display unit 180 or the audio output unit 185.

Moreover, the control unit 170 can control the display unit 180 to display images and control broadcast images inputted through the tuner 131, external input images inputted through the external device interface unit 135, images inputted through the network interface unit, or images stored in the storage unit 140 to be displayed on the display unit 180. In this case, an image displayed on the display unit 180 can be a still image or video and also can be a 2D image or a 3D image.

Additionally, the control unit 170 can play content stored in the display device 100, received broadcast content, and external input content inputted from the outside, and the content can be in various formats such as broadcast images, external input images, audio files, still images, accessed web screens, and document files.

Moreover, the wireless communication unit 173 can perform a wired or wireless communication with an external electronic device. The wireless communication unit 173 can perform short-range communication with an external device. For this, the wireless communication unit 173 can support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication unit 173 can support wireless communication between the display device 100 and a wireless communication system, between the display device 100 and another display device 100, or between networks including the display device 100 and another display device 100 (or an external server) through wireless area networks. The wireless area networks can be wireless personal area networks.

Herein, the other display device 100 can be a mobile terminal such as a wearable device (for example, a smart watch, a smart glass, and a head mounted display (HMD)) or a smartphone, which is capable of exchanging data (or inter-working) with the display device 100. The wireless communication unit 173 can detect (or recognize) a communicable wearable device around the display device 100. Furthermore, if the detected wearable device is a device authenticated to communicate with the display device 100, the control unit 170 can transmit at least part of data processed in the display device 100 to the wearable device through the wireless communication unit 173. Accordingly, a user of the wearable device can use the data processed in the display device 100 through the wearable device.

The wireless communication unit 173 can be provided separated from the external device interface unit 135 and can be included in the external device interface unit 135.

The display unit 180 can convert image signals, data signals, or OSD signals, which are processed in the control unit 170, or images signals or data signals, which are received in the external device interface unit 135, into R, G, and B signals to generate driving signals.

Furthermore, the display device 100 shown in FIG. 3 is just one embodiment of the present invention and thus, some of the components shown can be integrated, added, or omitted according to the specification of the actually implemented display device 100.

That is, if necessary, two or more components can be integrated into one component or one component can be divided into two or more components and configured. Additionally, a function performed by each block is to describe an embodiment of the present invention and its specific operation or device does not limit the scope of the present invention.

According to another embodiment of the present invention, unlike FIG. 3, the display device 100 can receive images through the network interface unit 133 or the external device interface unit 135 and play them without including the tuner 131 and the demodulation unit 132.

For example, the display device 100 can be divided into an image processing device such as a set-top box for receiving broadcast signals or contents according to various network services and a content playback device for playing contents inputted from the image processing device.

In this case, an operating method of a display device according to an embodiment of the present invention described below can be performed by one of the display device described with reference to FIG. 3, an image processing device such as the separated set-top box, and a content playback device including the display unit 180 and the audio output unit 185.

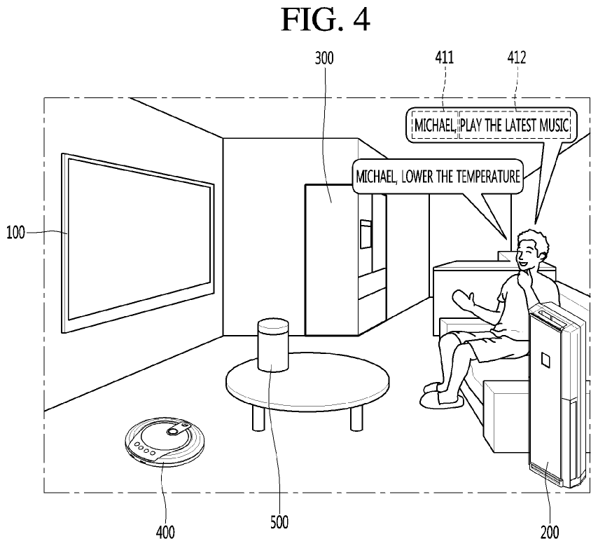

FIG. 4 is a diagram illustrating a use environment of a plurality of electronic devices according to an embodiment of the present disclosure.

The plurality of electronic devices 100, 200, 300, 400, and 500 may be electronic devices located together in a specific place. For example, the plurality of electronic devices 100, 200, 300, 400, and 500 may be a TV, an air conditioner, a refrigerator, a cleaner, or a speaker installed in one house.

On the other hand, wakeup words for calling the plurality of electronic devices 100, 200, 300, 400, and 500 may be identical to one another. For example, wakeup words for calling a TV, an air conditioner, a refrigerator, a cleaner, or a speaker may be all “Michael”.

When a user requests a specific electronic device to perform a specific function, the user may say a wakeup word 411 first and then a command word 412. For example, a user who requests the speaker to play the latest music will utter the speech “Michael (wakeup word), please play the latest music (command word)”.

In this case, the speaker may recognize that the speaker is called when the wakeup word of “Michael” is received.

Then, when the command word“Please play the latest music” is received, a function corresponding to the command word may be performed. For example, the artificial intelligence unit 1130 of the speaker may allow the function performing unit 1150 to search for recently-played music and output the found music.

On the other hand, when a plurality of electronic devices are arranged in a narrow environment such as a house, the speech uttered by the user may be also input to other electronic devices.

For example, the cleaner may also receive the speech input of “Michael (wakeup word), please play the latest music (command word)”.

In this case, since the cleaner uses the same wakeup word “Michael”, the cleaner may recognize that the cleaner is called, and attempt to perform a function corresponding to the command word“please play the latest music” when the wakeup word “Michael” is received. However, since the function corresponding to the command word “please play the latest music” is not a function performed by the cleaner, an error message such as “I didn't understand” may be output.

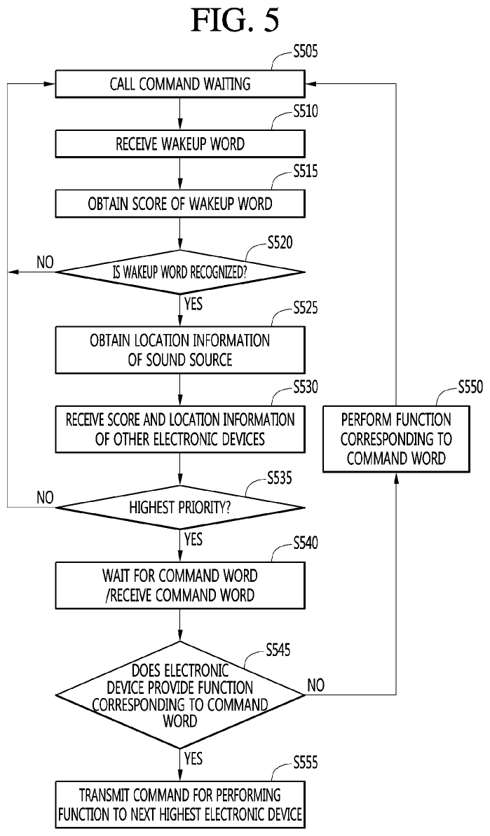

FIG. 5 is a diagram for describing a method of operating an electronic device according to an embodiment of the present disclosure.

Hereinafter, an operation of the first electronic device among the plurality of electronic devices will be described.

According to an embodiment of the present disclosure, a method of operating a first electronic device includes operating in a call command waiting mode (S505), receiving a speech input including a wakeup word (S510), obtaining a score of the wakeup word (S515), determining that the wakeup word has been received based on the score of the wakeup word (S520), obtaining location information of a sound source that has uttered the wakeup word (S525), receiving at least one of score and location information of one or more other electronic devices (S530), determining whether the electronic device is a highest priority based on at least one of the score and position information of the electronic device and at least one of the score and position information of the one or more other electronic device (S535), entering a command waiting state and receiving a speech input including a command word (S540), determining whether the electronic device provides a function corresponding to the command word (S545), transmitting the command word to an electronic device having a second highest priority when the electronic device does not provide a function corresponding to the command word (S550), and performing the function corresponding to the command word when the electronic device provides the function corresponding to the command word (S555).

Each of the above-described steps may be resulted by dividing the operation of the first electronic device into sub-operations, and the plurality of steps may be integrated, and at least some of the steps may be omitted.

Meanwhile, S505 to S520 are commonly applied to first, second and third embodiments as described below, and will be described first.

The first electronic device may operate in a call command waiting state (S505). Here, the call command waiting state may refer to a state of receiving a sound through the input unit 1120 and determining whether a wakeup word is included in the received sound.

On the other hand, the input unit 1120 may receive a speech input including a wakeup word from a sound source (S510). Here, the sound source may be a user who utters a wakeup word and a command word.

In detail, when the speech signal is received through the input unit 1120, the artificial intelligence unit 1130 may calculate a score of a keyword recognition mechanism (S515). In addition, when the calculated score is equal to or greater than a reference value, it may be determined that a wakeup word is included in the speech input.

More specifically, when the speech signal is received, the artificial intelligence unit 1130 may perform preprocessing such as reverberation removal, echo cancellation, and noise removal. In addition, the artificial intelligence unit 1130 may extract a feature vector used for speech recognition from the preprocessed speech signal. In addition, the artificial intelligence unit 1130 may calculate a score for the received speech signal based on the comparison between the feature vector and previously-stored (pre-learned) data and a probability model. Here, the score may be expressed numerically as representing a degree of similarity between the input speech and a pre-stored wakeup word (that is, a degree of matching between the input speech and the pre-stored wakeup word).

In this case, the artificial intelligence unit 1130 may detect a predetermined keyword from speech signals that is continuously inputted, based on a keyword detection technology. In addition, the artificial intelligence unit 1130 may calculate a score representing a similarity between a keyword and a pre-stored wakeup word.

When the calculated score is greater than or equal to the reference value, the artificial intelligence unit 1130 may determine that the speech input including a wakeup word has been received (S520).

Meanwhile, when the wakeup word is not included in the speech input, that is, the calculated score is smaller than the reference value, the artificial intelligence unit 1130 may return to the call command waiting state again.

On the other hand, when it is determined that the wakeup word is included in the speech input, the artificial intelligence unit 1130 may obtain a degree of recognition of the wakeup word in the electronic device 1000.

Here, the degree of recognition of the wakeup word in the first electronic device may mean a possibility of calling the first electronic device among the plurality of electronic devices.

Therefore, as the degree of recognition is higher in the plurality of electronic devices, the possibility of being called by the user may increase. For example, when the degree of recognition of the wakeup word in the TV is higher than the degree of recognition of the wakeup word in the speaker, a possibility that the user may be more likely to call the TV may increase.

Meanwhile, the degree of recognition may be obtained based on at least one of the score of the wakeup word in the first electronic device and location information of the sound source in the first electronic device.

First, a first embodiment in which a degree of recognition is obtained using the score of the wakeup word will be described.

It has been described above that the score of the wakeup word is calculated in the first electronic device. In the first embodiment, the score of the wakeup word in the first electronic device may be the degree of recognition of the wakeup word in the first electronic device.

Meanwhile, a second embodiment in which a degree of recognition is obtained based on location information of a sound source in the electronic device 1000 will be described.

The first electronic device may obtain location information of the sound source (S525). Here, the sound source may be a user who utters a speech. In addition, the location information of the sound source may mean a relative location of the sound source with respect to the first electronic device, and may include at least one of a distance from the sound source and a direction of the sound source with respect to the first electronic device.

To this end, the input unit 1120 may include a multi-channel microphone array, and the artificial intelligence unit 1130 may detect a signal generated from the sound source based on sound signals received through a plurality of microphones, and track the distance from the sound source and direction of the sound source according to various known location tracking algorithms.

That is, the degree of recognition may be determined based on the distance between the first electronic device and the sound source and the direction of the sound source with respect to the first electronic device. In this case, the artificial intelligence unit 1030 may calculate the degree of recognition by giving a higher weight to the direction of the sound source than the distance from the sound source. For example, when a user who is close to a TV shouts a wakeup word while looking at a refrigerator at a long distance, the degree of recognition of the wakeup word in the refrigerator may be higher than that of the wakeup word in the TV.

Meanwhile, a third embodiment in which a degree of recognition is obtained based on a score of a wakeup word and location information of a sound source in the first electronic device will be described.

The artificial intelligence unit 1130 may obtain a degree of recognition of the wakeup word in the first electronic device based on the score of the wakeup word in the first electronic device and the location information of a sound source in the first electronic device 1000.

In this case, the artificial intelligence unit 1130 may calculate the degree of recognition by giving a higher weight to the score of the wakeup word in the electronic device 1000 than the location information of the sound source in the first electronic device.

Meanwhile, other electronic devices than the first electronic device among the plurality of electronic devices may also perform the same operation as the first electronic device.

That is, each of the plurality of electronic devices operates in a call command waiting state, and when a speech signal is received, it is possible to determine whether a speech input including a wakeup word is received. Also, an electronic device that has determined that the speech input including a wakeup word is received among the plurality of electronic devices may obtain a degree of recognition of the wakeup word in the electronic device itself.

In addition, the electronic device that has determined that the speech input including the wakeup word is received may obtain the degree of recognition of the wakeup word in the electronic device itself.

For example, the second electronic device may calculate the score of the wakeup word based on the speech input received from the second electronic device, and obtain location (distance and direction) information of the sound source based on the second electronic device.

Meanwhile, the plurality of electronic devices may share the degree of recognition of the wakeup word in each electronic device with other devices.

For example, it is assumed that there are a first electronic device, a second electronic device, a third electronic device, a fourth electronic device, a fifth electronic device, the first electronic device has obtained the degree of recognition of the wakeup word in the first electronic device, the second electronic device has obtained the degree of recognition of the wakeup word in the second electronic device, and the third electronic device has obtained the degree of recognition of the wakeup word in the third electronic device.

In this case, the artificial intelligence unit 1130 of the first electronic device may transmit the degree of recognition of the wakeup word in the first electronic device to one or more other electronic devices. In addition, the artificial intelligence unit 1130 of the first electronic device may receive the degree of recognition of the wakeup word in each of the one or more other electronic devices from the one or more other electronic devices (S530).

For example, the first electronic device may transmit the degree of recognition of the wakeup word in the first electronic device to the second electronic device and the third electronic device. Also, the first electronic device may receive a degree of recognition of the wakeup word in the second electronic device from the second electronic device. Also, the first electronic device may receive a degree of recognition of the wakeup word in the third electronic device from the third electronic device.

In addition, the second electronic device and the third electronic device may also perform the same operation as the first electronic device.

Meanwhile, the artificial intelligence unit 1130 may obtain a priority of the first electronic device based on the degree of recognition of the wakeup word in the first electronic device and the degree of recognition of the wakeup word in each of the one or more other electronic devices.

Here, the priority may be determined based on the degree of recognition. For example, when the degree of recognition of the first electronic device is the highest, the degree of recognition of the second electronic device is the middle, and the degree of recognition of the third electronic device is the lowest, the first electronic device may have the highest priority and the second electronic device may have the next highest priority.

Meanwhile, the priority may be calculated in other ways by various methods of calculating the degree of recognition.

In detail, in the first embodiment, the artificial intelligence unit 1130 may obtain a score of the wakeup word in the first electronic device, and receive a score of the wakeup word in each of the one or more other electronic devices. In this case, the artificial intelligence unit 1130 may obtain a priority of the first electronic device based on the score of the wakeup word in the first electronic device and the score of the wakeup word in each of the one or more other electronic devices.

In addition, in the second embodiment, the artificial intelligence unit 1130 may obtain location information of the sound source in the first electronic device, and may receive location information of the sound source in each of the one or more other electronic devices. In this case, the artificial intelligence unit 1130 may obtain the priority of the first electronic device based on the location information of the sound source in the first electronic device and the location information of the sound source in each of the one or more other electronic devices.

In addition, in the third embodiment, the artificial intelligence unit 1130 may obtain a degree of recognition in the first electronic device using the score of the wakeup word and the position information of the sound source in the first electronic device. In addition, the second electronic device may obtain a degree of recognition of the second electronic device by using the score of the wakeup word and the location information of the sound source in the second electronic device, and the third electronic device may also obtain a degree of recognition of the third electronic device by using the score of the wakeup word and the location information of the sound source in the third electronic device.

In this case, the artificial intelligence unit 1130 may receive a degree of recognition of a wakeup word in each of the one or more other electronic devices. In addition, the artificial intelligence unit 1130 may obtain a priority of the first electronic device based on the degree of recognition of the wakeup word in the first electronic device and the degrees of recognition of the wakeup word in one or more other electronic devices (second and third electronic devices).

On the other hand, the priority may be determined by appropriately combining the score and the location information.

In detail, the artificial intelligence unit 1130 may obtain information on a plurality of electronic devices having a score higher than or equal to a predetermined priority, and determine one of the plurality of electronic devices having the score higher than or equal to the predetermined priority as an electronic device having the highest priority, based on the location information of the sound source.

For example, it is assumed that it is determined based on scores that the first electronic device has the highest priority, the second electronic device has the next highest priority, the third electronic device has the third priority, and it is determined based on location information that the first electronic device has the next highest priority, the second electronic device has the highest priority, the third electronic device has the third priority. It is also assumed that the predetermined priority is the second priority.

In this case, the artificial intelligence unit 1130 may obtain information about the first electronic device and the second electronic device having a score higher than or equal to the second priority. In addition, the artificial intelligence unit 1130 may determine that the second electronic device among the first electronic device and the second electronic device has the highest priority based on the location information of the sound source.

Meanwhile, when the first electronic device has not the highest priority, the artificial intelligence unit 1130 may return to the call command waiting state again (S535).

In addition, the artificial intelligence unit 1130 may enter a command waiting state when the first electronic device has the highest priority (S535, S540). Here, the command waiting state may refer to a state in which when a speech input is received, a command included in speech input is able to be recognized by processing the received speech input using the continuous speech engine.

In this case, the storage 1140 may store information about functions provided by the first electronic device and command word information corresponding thereto.

On the other hand, when the first electronic device has the highest priority, the second electronic device and the third electronic device have not the highest priority, and therefore the second electronic device and the third electronic device may return to the call command waiting state again.

Meanwhile, when the first electronic device operates in a command waiting state and receives a speech input including a command word, the artificial intelligence unit 1130 may recognize the command word included in the speech input by processing the speech input using a continuous speech engine. Here, to recognize the command word may mean to extract the command word from the speech input and to recognize the meaning of the command word.

In this case, the artificial intelligence unit 1130 may perform a function corresponding to the command word.

For example, when the first electronic device is a TV and the command word is “Increase the volume,” the artificial intelligence unit 1130 may allow the function performing unit 1150 to increase the volume of output sound.

As described above, the present disclosure may prevent confusion that may occur when the plurality of electronic devices are forced to use the same wakeup word.

Specifically, the present disclosure may determine which electronic device is called using a degree of recognition of the wakeup word. For example, a score may be affected by noise, ringing, and reverberation of sound, which may be changed according to a distance between a user and the electronic device and a direction of the user.

That is, the present disclosure may determine which electronic device the user is likely to call by calculating and comparing scores.

In addition, the score value may not indicate the user's position due to effects such as reverberation. For example, there is a case in which an air conditioner is located at the corner.

In this case, the electronic device may directly measure the distance to the user and the direction of the user, and compare the distance and the direction with those of other electronic devices to determine which electronic device the user is likely to call.

In addition, the accuracy of the determination may be further improved by using all of the score, the distance to the user and the direction of the user.

In addition, it is possible to determine which electronic device the user is most likely to call, and allow the electronic device with the highest probability (that is, the highest recognition rate) to recognize and execute a command, thereby providing an operation corresponding to the user's intention.

For example, there are many cases in which the user says a wakeup word while looking at the electronic device which the user wants to call. In addition, when the user says “decrease the temperature” while looking at the air conditioner with his/her back to the refrigerator, a degree of recognition in the air conditioner may be designed to be higher than that in the refrigerator. The air conditioner may recognize that the air conditioner itself is called by comparing degrees of recognition, and thus may perform a function of decreasing the temperature. However, the refrigerator may determine that the refrigerator itself is not called and may not perform a function corresponding to the command.

As another example, there is a case in which the user calls an electronic device at a short distance. For example, in a case in which the speaker is in the kitchen, the TV is in the living room, and the user is in front of the TV, when the user may say “lower the volume”, the degree of recognition in the TV may be higher than the degree of recognition in the speaker. In this case, the TV may recognize that the TV itself is called and perform a function of lowering the volume.

In addition, according to the present disclosure, it is possible to provide a service more in accord with the user's intention, by appropriately combining a weight of data related to the distance to the user and a weight of data related to the direction to the user among data related to the score or the location information. For example, when the user, who is in front of the TV, says “lower the temperature” while looking at the refrigerator at a long distance, as a rule of thumb, there is high possibility that the user calls the refrigerator. Accordingly, the present disclosure may provide a service that more closely matches the intention of the user by giving a higher weight to data related to the direction with the user.

In addition, the present disclosure may prevent confusion caused by other electronic devices that do not recognize the command word by allowing only the electronic device having the highest priority, which is most likely to be called, to recognize a command word and perform a function.

On the other hand, since it is impossible to accurately calculate the degree of recognition, there may occur a case in which a function corresponding to a command word cannot be provided although the degree of recognition is highest. For example, in a case in which the first electronic device is a TV and the second electronic device is an air conditioner, when the user inputs a command word “lower the temperature” to call the air conditioner, the TV represents the highest degree of recognition.

Therefore, when the first electronic device operates in a command waiting state and receives a speech input including a command word, the artificial intelligence unit 1130 may determine whether a function corresponding to the command word is a function provided by the first electronic device (S545).

When the function corresponding to the command word is the function provided by the first electronic device, the artificial intelligence unit 1130 may allow the function performing unit 1150 to perform the function corresponding to the command word (S555).

Meanwhile, the function corresponding to the command word may not be the function provided by the first electronic device. In this case, the artificial intelligence unit 1130 may not perform the function corresponding to the command word.

In addition, the artificial intelligence unit 1130 may transmit a command for performing the function corresponding to the command word to an electronic device having the next highest priority (S550).

On the other hand, the electronic device having the next highest priority may be in a state of returning to the call command waiting state. Therefore, the electronic device having the next highest priority may not recognize the command word.

Accordingly, the command for performing the function corresponding to the command word may include speech signal information corresponding to the speech input including the command word or the command word recognized by the electronic device having the highest priority.

In this case, the electronic device having the next highest priority may receive a command for performing a function corresponding to the command word.

In addition, when the speech signal information is included in the command for performing the function corresponding to the command word, the electronic device having the next highest priority may recognize the command word based on the received speech signal information.

The electronic device having the next highest priority may determine whether the electronic device having the next highest priority provides the function corresponding to the command word, based on the recognized command word.

In addition, when the electronic device having the next highest priority provides the function corresponding to the command word, the electronic device having the next highest priority may perform the function corresponding to the command word.

For example, when the first electronic device having the highest priority is a TV, the second electronic device having the next highest priority is an air conditioner, and the user inputs a command word of “lower the temperature”, the TV may not perform the function corresponding to the command word. In this case, the TV may transmit information about the command word of “lower the temperature” to the air conditioner. In addition, the air conditioner may determine whether the air conditioner provides a function corresponding to the command word of “lower the temperature” and perform the function corresponding to the command word of “lower the temperature” (that is, increase air volume or decrease the temperature of discharged air).

On the contrary, when the first electronic device is an electronic device having the next highest priority, the first electronic device has returned to a call command waiting state. In this case, the first electronic device may receive a command for performing a function corresponding to the command word from the electronic device having the highest priority. In this case, the artificial intelligence unit 1130 may determine whether a function corresponding to the command word is a function provided by the first electronic device, based on the recognized command word. Also, when the function corresponding to the command word is a function provided by the first electronic device, the artificial intelligence unit 1130 may perform the function corresponding to the command word. In addition, when the function corresponding to the command word is not a function provided by the first electronic device, the artificial intelligence unit 1130 may transmit a command for performing a function corresponding to the command word to an electronic device having the third priority.

Since the degree of recognition represents how accurately the user's intention is inferred through the distance or the direction of the user, it may not be able to accurately grasp the user's intention.

Accordingly, it may not be the user's intention to call an electronic device having the highest priority, and thus, the electronic device having the highest priority may not be able to perform a function corresponding to the command word.

In this case, the electronic device may transmit a command for performing the function to an electronic device having the second highest priority, which represents the second-highest priority likely to be called by the user, thus providing a function intended by the user without re-inputting a speech.

Meanwhile, in the present embodiment, only the electronic device having the highest priority has been described as entering the command word waiting state, but is not limited thereto. In detail, an electronic device having a predetermined priority or higher may enter the command waiting state.

For description, it is assumed that the first electronic device, the second electronic device, the third electronic device, and the fourth electronic device among the plurality of electronic devices have recognized the wakeup word. Further, it is assumed that the first electronic device has the highest priority, the second electronic device has the next highest priority, the third electronic device has the third priority, and the fourth electronic device has the fourth priority.

Meanwhile, the predetermined priority may be the third priority. In this case, an electronic device having not lower than the third priority which is the predetermined priority, may enter the command word waiting state.

In this case, the first electronic device, the second electronic device, and the third electronic device may enter the command word waiting state. When the command word is received, the first electronic device, the second electronic device, and the third electronic device may recognize the received command word.

When a speech input including the command word is received, the artificial intelligence unit of the first electronic device may determine whether the first electronic device provides a function corresponding to the command word.

When the second electronic device also receives the speech input including the command word, the artificial intelligence unit of the second electronic device may determine whether the second electronic device provides the function corresponding to the command word.

When the third electronic device also receives the speech input including the command word, the artificial intelligence unit of the third electronic device may determine whether the third electronic device provides the function corresponding to the command word.

For example, when the first electronic device is a TV, the second electronic device is an air conditioner, the third electronic device is a refrigerator, and the command word is “lower the temperature”, the first electronic device may determine that the first electronic device is not able to provide the function corresponding to the command word and the second electronic device and the third electronic device may determine that the second electronic device and the third electronic device are able to provide the function corresponding to the command word.

In this case, the second electronic device and the third electronic device may wait without immediately performing a function corresponding to the command word.

Meanwhile, since the first electronic device does not provide a function corresponding to the command word, the first electronic device may transmit a command for performing a function corresponding to the command word to the second electronic device. Meanwhile, since the second electronic device has also recognized the command word, the recognized command word does not need to be included in the command for performing a function corresponding to the command word.

On the other hand, the second electronic device has already been determined that the second electronic device is able to provide a function corresponding to the command word. In this state, when a command for performing a function corresponding to the command word is received from the first electronic device, the second electronic device may perform a function corresponding to the command word. For example, the air conditioner, which is the second electronic device, may operate to lower the room temperature.

When the second electronic device performs the function corresponding to the command word, the second electronic device does not transmit a command for performing a function corresponding to the command word to the third electronic device.

Meanwhile, the refrigerator, which is the third electronic device, may also provide a function corresponding to the command word of “lower the temperature”. However, since the command for performing the function is not transmitted from the second electronic device, the third electronic device may not perform a function corresponding to the command word.

As described above, according to the present disclosure, it is possible to provide a function intended by a user without re-inputting a speech by transmitting a command for performing the function to an electronic device of the next highest priority when the electronic device having the highest priority cannot perform a function corresponding to the command word.

In addition, when the electronic device having the next highest priority provides the function, the command for performing the function is not transmitted to the electronic device having the third priority, thereby preventing confusion that may occur when a plurality of electronic devices provide the function.

Meanwhile, the above-described operations of the second electronic device and the third electronic device may be applied to the first electronic device as it is.

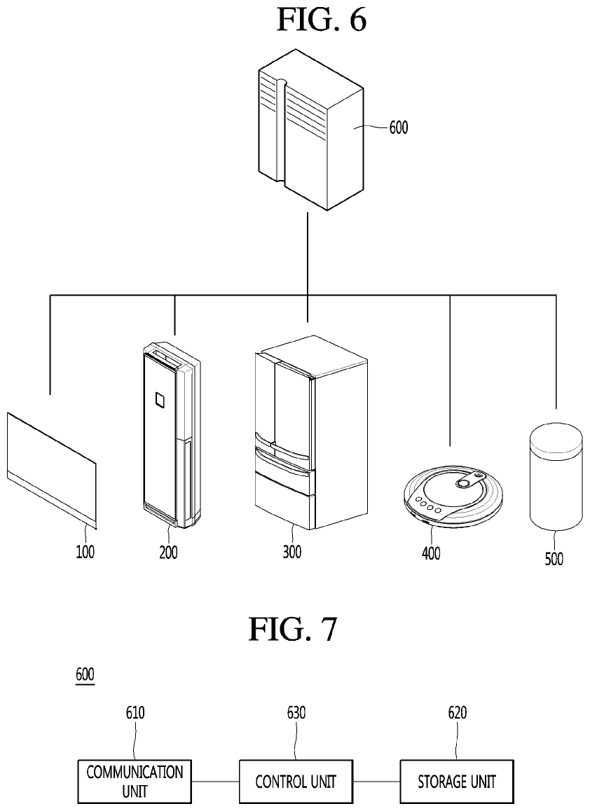

FIG. 6 is a diagram illustrating a plurality of electronic devices and a server according to another embodiment of the present disclosure.

A plurality of electronic devices 100, 200, 300, 400 and 500 may communicate with a server 600. In more detail, each of the plurality of electronic devices may include a communication unit, and the communication unit may provide an interface for connecting the electronic device to a wired/wireless network including an Internet network. The communication unit may transmit or receive data to or from the server through the connected network or another network linked to the connected network.

In FIGS. 1 to 5, it is described that each of the plurality of electronic devices 100, 200, 300, 400, and 500 is equipped with both a keyword engine for recognizing a wakeup word and a continuous speech engine for recognizing a general command for performing a function. Accordingly, each of the plurality of electronic devices 100, 200, 300, 400, and 500 may perform both recognition of a wakeup word and recognition of a command word.

Alternatively, each of the plurality of electronic devices 100, 200, 300, 400, and 500 may recognize a wakeup word, and the server may recognize a command word and transmit a control command to the electronic device again.

FIG. 7 is a diagram for describing a server according to an embodiment of the present disclosure.

The server 600 according to an embodiment of the present disclosure may include a communication unit 610, a storage unit 620, and a control unit 630.

The communication unit 610 may provide an interface for connecting the server 600 to a wired/wireless network including an Internet network. The communication unit 610 may transmit or receive data to or from a plurality of electronic devices through the connected network or another network linked to the connected network.

The storage unit 1140 may store data (e.g., information about at least one algorithm for machine learning) for the operation of the control unit 630. In addition, the storage unit 6240 may store data or an application program for speech recognition and driving of a continuous speech engine, and may be driven by the control unit 630 to perform a speech recognition operation.

In addition, the storage unit 630 may store information about functions provided by the plurality of electronic devices 100, 200, 300, 400, and 500 and information about command words corresponding thereto.

The control unit 630 may perform all the functions of the artificial intelligence unit 1130 described with reference to FIG. 2.

In addition to the operation related to the application program, the control unit 630 may generally control the overall operation of the server 600. The control unit 630 may provide or process information or a function appropriate to a user by processing signals, data, information, and the like, which are input or output through the above-described components, or by running an application program stored in the storage unit 620.

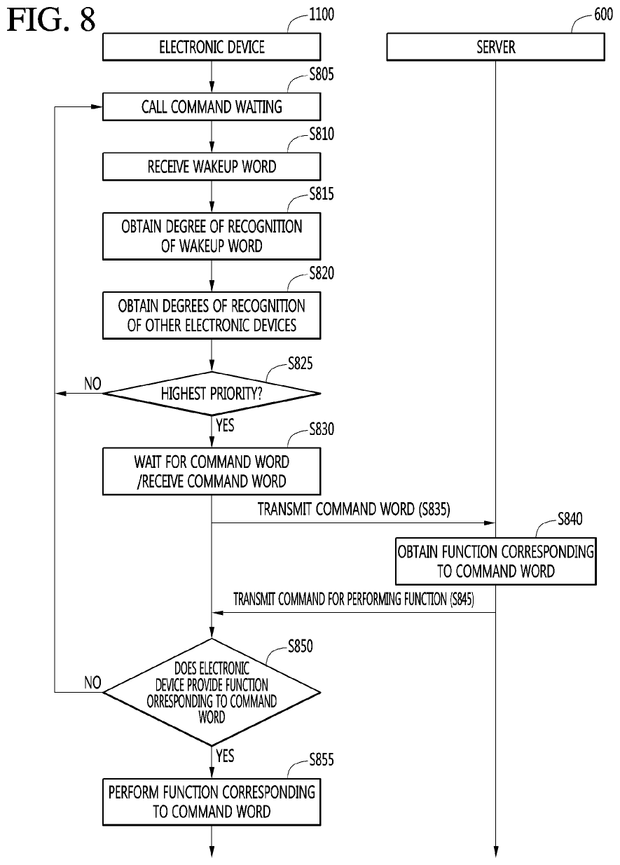

FIG. 8 is a diagram for describing a method of operating an electronic device and a server according to a fourth embodiment of the present disclosure.

Hereinafter, operations of a first electronic device among a plurality of electronic devices and a server will be described.

According to an embodiment of the present disclosure, a method of operating a first electronic device includes operating in a call command waiting mode (S805), receiving a speech input including a wakeup word (S810), obtaining a degree of recognition of the wakeup word (S815), receiving degrees of recognition of one or more other electronic devices (S820), determining whether the first electronic device has the highest priority based on the degree of recognition of the first electronic device and the degrees of recognition of the one or more other electronic devices (S825), when the electronic device has a highest priority, enters a command waiting state and receiving a speech input including a command word (S830), transmitting command word information to a server (S830), receiving a command for performing a function corresponding to the command word (S845), determining whether the first electronic device provides a function corresponding to the command word (S850), and performing the function corresponding to the command word (S855).

Here, the description of S505 to S540 described with reference to FIG. 5 may be applied to the steps of S805 to S830 and thus detailed description will be omitted.

When the first electronic device has the highest priority and receives a speech input including a command word, the artificial intelligence unit 1130 may transmit command word information corresponding to the speech input including the command word to the server 600 (S835).

The command word information may be speech signal information corresponding to a speech input including a command word. Specifically, the command word information may be speech signal information in a state in which the command word is not recognized because it is not processed by the continuous speech engine.

Meanwhile, the communication unit 610 of the server 600 may receive the command word information.

In addition, the control unit 630 of the server 600 may recognize the command word included in the speech input by processing the command word information using the continuous speech engine. Here, to recognize the command word may mean to extract the command word from the speech input and to recognize the meaning of the command word.

In addition, the control unit 630 of the server 600 may obtain a function corresponding to the command word (S840). In addition, the control unit 630 of the server 600 may transmit a command for performing a function corresponding to the command word to the first electronic device (S845). Here, the command for performing a function corresponding to the command word may include information about the function corresponding to the command word.

Meanwhile, the artificial intelligence unit 1130 of the first electronic device that has received a command for performing a function corresponding to the command word may determine whether the first electronic device provides a function corresponding to the command word (S850).

When the function corresponding to the command word is not provided by the first electronic device, the artificial intelligence unit 1130 may return to the call command waiting state without performing the function corresponding to the command word.

In addition, when the function corresponding to the command word is a function provided by the first electronic device, the artificial intelligence unit 1130 may allow the function performing unit 1150 to perform a function corresponding to the command word (S855).

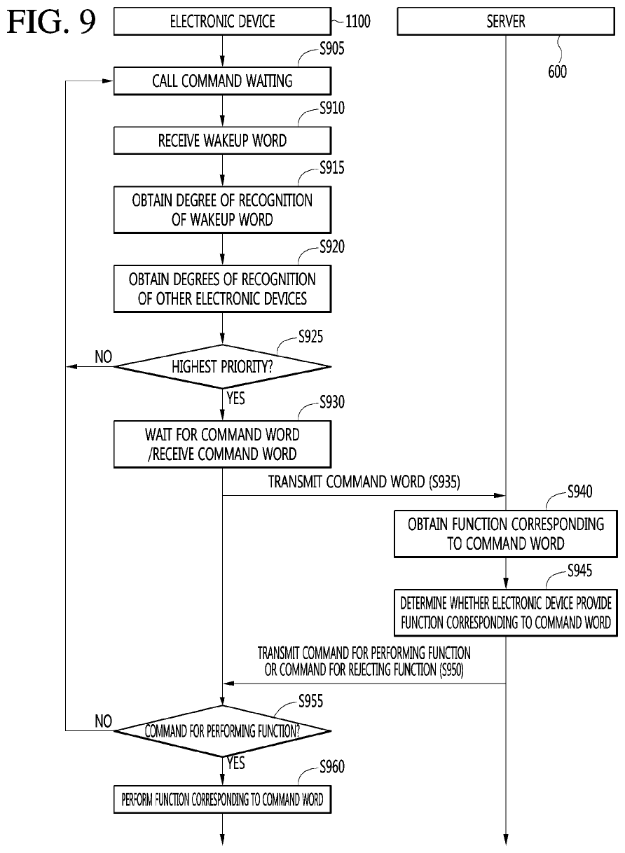

FIG. 9 is a diagram for describing a method of operating an electronic device and a server according to a fifth embodiment of the present disclosure.

Hereinafter, operations of the first electronic device among the plurality of electronic devices and the server will be described.

In accordance with an embodiment of the present disclosure, a method of operating a first electronic device includes operating in a call command waiting mode (S905), receiving a speech input including a wakeup word (S910), obtaining a degree of recognition of the wakeup word (S915), receiving degrees of recognition of one or more other electronic devices (S920), determining whether the first electronic device has the highest priority based on the degree of recognition of the first electronic device and the degrees of recognition of the one or more other electronic devices (S925), when the electronic device has a highest priority, enters a command waiting state and receiving a speech input including a command word (S930), transmitting command word information to a server (S935), receiving a command for performing a function corresponding to the command word or a command for rejecting the function (S950), determining whether the received command is a command for performing a function corresponding to the command word (S955); and performing a function corresponding to the command word when the received command is a command for performing the function corresponding to the command word (S960).

Here, the description of S805 to S830 described with reference to FIG. 8 may be applied to the steps of S905 to S930 as they are and thus detailed description will be omitted.

When the first electronic device has the highest priority and receives a speech input including a command word, the artificial intelligence unit 1130 may transmit command word information corresponding to the speech input including the command word to the server 600 (S935).

Meanwhile, the communication unit 610 of the server 600 may receive the command word information.

In addition, the control unit 630 of the server 600 may recognize the command word included in the speech input by processing the command word information using the continuous speech engine. Here, to recognize the command word may mean to extract the command word from the speech input and to recognize the meaning of the command word.

In addition, the control unit 630 of the server 600 may obtain a function corresponding to the command word (S940).

In addition, the control unit 630 of the server 600 may determine whether the first electronic device provides a function corresponding to the command word based on the function information provided by the plurality of electronic devices 100, 200, 300, 400, and 500 stored in the storage unit 630 and command word information corresponding thereto (S945).

When the function corresponding to the command word is not a function provided by the first electronic device, the control unit 630 may transmit a command for rejecting the function to the first electronic device, and when the function corresponding to the command word is a function provided by the first electronic device, the control unit 630 may transmit a command for performing a function corresponding to the command word to the first electronic device (S950).

Meanwhile, the artificial intelligence unit 1130 of the first electronic device may determine whether the received command is a command for performing a function corresponding to the command word (S955).

When the received command is not a command for performing a function corresponding to the command word (that is, a command for rejecting the function), the artificial intelligence unit 1130 may return to the call command waiting state without performing a function corresponding to the command word.

Meanwhile, when the received command is a command for performing a function corresponding to the command word, the artificial intelligence unit 1130 may perform a function corresponding to the command word (S960).

As described above, according to the present disclosure, the server that serves as an AI hub performs recognition of the command word, and thus a function for recognizing a command word does not need to be mounted in electronic devices. Therefore, it is possible to reduce the cost.

Also, since the electronic device receives and analyzes the wakeup word even when the server serves as an AI hub, there may still be a problem due to the use of the same wakeup word. However, the present disclosure may solve the problem caused by the use of the same wakeup word because only an electronic devices having the highest priority operates with the server.

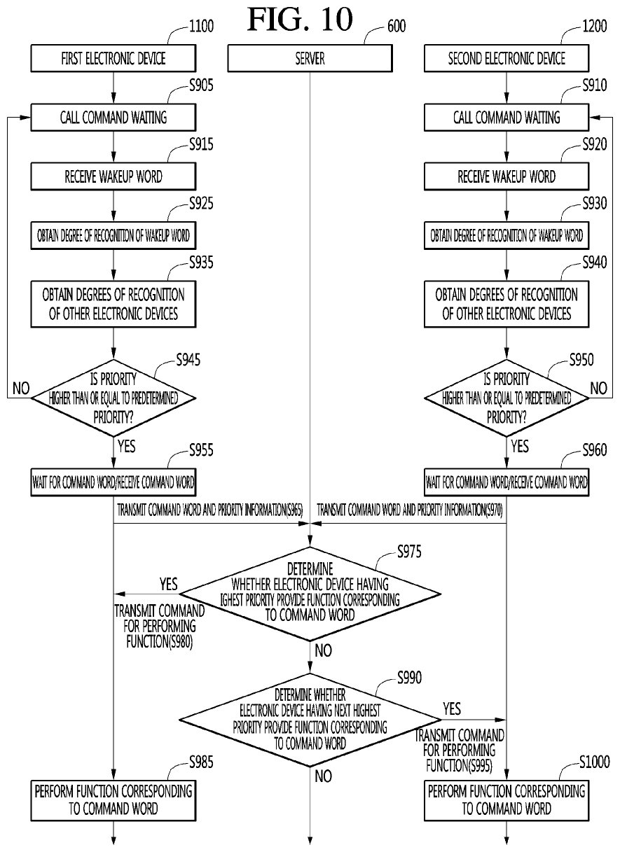

FIG. 10 is a diagram for describing a method of operating an electronic device and a server according to a sixth embodiment of the present disclosure.

Hereinafter, operations of the first electronic device, the second electronic device among the plurality of electronic devices and the server will be described. Here, the first electronic device may be an electronic device having the highest priority, and the second electronic device may be an electronic device having the next highest priority.

In accordance with an embodiment of the present disclosure, a method of operating a first electronic device includes operating in a call command waiting mode (S905), receiving a speech input including a wakeup word (S915), obtaining a degree of recognition of the wakeup word (S925), receiving degrees of recognition of one or more other electronic devices (S935), determining whether the first electronic device has a priority higher than or equal to a predetermined priority based on the degree of recognition of the first electronic device and the degrees of recognition of the one or more other electronic devices (S945), when the first electronic device has a priority higher than or equal to a predetermined priority, entering a command waiting state and receiving a speech input including a command word (S955); transmitting command word information and priority information to a server (S965), and when a command for performing a function corresponding to the command word is received, performing the function corresponding to the command word (S980).

In accordance with an embodiment of the present disclosure, a method of operating a second electronic device includes operating in a call command waiting mode (S910), receiving a speech input including a wakeup word (S920), obtaining a degree of recognition of the wakeup word (S930), receiving degrees of recognition of one or more other electronic devices (S940), determining whether the second electronic device has a priority higher than or equal to a predetermined priority based on the degree of recognition of the second electronic device and the degrees of recognition of the one or more other electronic devices (S950), when the second electronic device has a priority higher than or equal to a predetermined priority, entering a command waiting state and receiving a speech input including a command word (S960), transmitting command word information and priority information to a server (S970), and when a command for performing a function corresponding to the command word is received, performing the function corresponding to the command word (S1000).

Here, the descriptions of S905 to S920 given with reference to FIG. 9 may be applied to steps S905, S915, S925, S935 of the first electronic device, and steps S910, S920, S930, and S940 of the second electronic device as they are and therefore, detailed description will be omitted.

For description, it is assumed that the first electronic device, the second electronic device, the third electronic device, and the fourth electronic device among the plurality of electronic devices have recognized the wakeup word. Further, it is assumed that the first electronic device has the highest priority, the second electronic device has the next highest priority, the third electronic device has the third priority, and the fourth electronic device has the fourth priority. It is also assumed that the predetermined priority is the second priority.

The control unit of the first electronic device may determine whether the first electronic device has a priority equal to or higher than a predetermined priority (S945).

In addition, when the first electronic device has a priority equal to or higher than a predetermined priority, the control unit of the first electronic device may enter a command waiting state and receive a speech input including a command word (S955).

On the other hand, when the first electronic device has a priority equal to or higher than the predetermined priority and receives a speech input including a command word, the control unit of the first electronic device may transmit command word information corresponding to the speech input including the command word and the priority information of the first electronic device to the server 600 (S965). Here, the priority information of the first electronic device may include information representing that the first electronic device has the highest priority.

On the other hand, the control unit of the second electronic device may determine whether the second electronic device has a priority equal to or higher than the predetermined priority (S950).

In addition, when the second electronic device has a priority equal to or higher than the predetermined priority, the control unit of the second electronic device may enter a command waiting state and receive a speech input including a command word (S960).

On the other hand, when the second electronic device has a priority equal to or higher than the predetermined priority and receives a speech input including a command word, the control unit of the second electronic device may transmit command word information corresponding to the speech input including the command word and the priority information to the server 600 (S970). Here, the priority information of the second electronic device may include information representing that the second electronic device has the next highest priority.

The control unit of the third electronic device may determine whether the third electronic device has a priority equal to or higher than the predetermined priority.

Meanwhile, since the priority of the third electronic device has a priority lower than the predetermined priority, the third electronic device may return to the call command waiting state.

Meanwhile, the communication unit 610 of the server 600 may receive the command word information and the priority information of the first electronic device from the first electronic device (S965), and receive command word information and the priority information of the second electronic device from the second electronic device (S970).

Meanwhile, the control unit 630 of the server 600 may recognize the command word included in the speech input by processing the command word information received from the first electronic device or the command word information received from the second electronic device using a continuous speech engine. Here, to recognize the command word may mean to extract the command word from the speech input and to recognize the meaning of the command word.

In addition, the control unit 630 of the server 600 may obtain a function corresponding to the command word.

In this case, the control unit 630 of the server 600 may determine whether a function corresponding to the command word is a function provided by an electronic device having the highest priority, based on the received priority information (S975). That is, the control unit 630 of the server 600 may determine whether a function corresponding to the command word is a function provided by the first electronic device.

Meanwhile, when the function corresponding to the command word is a function provided by the first electronic device, the control unit 630 may transmit a command for performing the function corresponding to the command word to the first electronic device (S980).

In this case, the first electronic device may receive the command for performing a function corresponding to the command word. In addition, when the command for performing a function corresponding to the command word is received, the control unit of the first electronic device may perform the function corresponding to the command word (S985).

Meanwhile, when the function corresponding to the command word is not provided by the first electronic device, the control unit 630 may determine whether the function corresponding to the command word is a function provided by an electronic device having the next highest priority. That is, the control unit 630 may determine whether the function corresponding to the command word is a function provided by the second electronic device (S990).

In addition, when the function corresponding to the command word is a function provided by the second electronic device, the control unit 630 may transmit a command for performing the function corresponding to the command word to the second electronic device (S995).

In this case, the second electronic device may receive the command for performing a function corresponding to the command word. In addition, when the command for performing a function corresponding to the command word is received, the control unit of the second electronic device may perform the function corresponding to the command word (S1000).

Since the degree of recognition represents how accurately the user's intention is inferred through the distance or the direction of the user, it may not be able to accurately grasp the user's intention.

Accordingly, it may not be the user's intention to call an electronic device having the highest priority, and thus, the electronic device having the highest priority may not be able to perform a function corresponding to the command word.

In this case, the server may first determine whether the electronic device having the highest priority provides the function corresponding to the command word and transmit a command for performing the function, so that the electronic device having the highest priority which is most likely to be called by the user preferentially provides the function.

In addition, it is possible to determine whether an electronic device having the next highest priority provides the function corresponding to the command word and transmits the command for performing the function when the electronic device having the highest priority is not able to provide the function, thereby providing the function intended by the user without re-inputting a speech.

On the other hand, the control unit is generally in charge of controlling the device, and may be used interchangeably with terms such as a central processing unit, a microprocessor, and a processor.

The invention may also be embodied as computer readable codes on a computer readable recording medium. The computer readable recording medium is any data storage device that may store data which may be thereafter read by a computer system. Examples of the computer readable recording medium include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. The computer may include the control unit 180 of the mobile terminal. The above exemplary embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. An electronic device comprising:
an input interface configured to receive a speech input including a wakeup word and a command word from a sound source;
a communication interface configured to communicate with one or more other electronic devices; and
an artificial intelligence interface configured to obtain a degree of recognition of the wakeup word in the electronic device, receive a degree of recognition of the wakeup word in each of the one or more other electronic devices, and perform a function corresponding to the command word when the electronic device has a highest priority based on the degree of recognition of the wakeup word in the electronic device and the degree of recognition of the wakeup word in each of the one or more other electronic devices,
wherein the degree of recognition of the wakeup word in the electronic device is obtained based on at least one of a score of the wakeup word or location information of the sound source, in the electronic device.

2. The electronic device of claim 1, wherein the electronic device and the one or more other electronic devices are called by a same wakeup word.

3. The electronic device of claim 1, wherein the artificial intelligence interface is configured to obtain a priority of the electronic device based on the score of the wakeup word in the electronic device and the score of the wakeup word in each of the one or more other electronic devices, and perform a function correspond to the command word when the electronic device has the highest priority.

4. The electronic device of claim 1, wherein the artificial intelligence interface is configured to obtain a priority of the electronic device based on location information of the sound source in the electronic device and location information of the sound source in each of the one or more other electronic devices, and perform a function correspond to the command word when the electronic device has a highest priority.

5. The electronic device of claim 1, wherein the artificial intelligence interface is configured to obtain a priority of the electronic device based on the degree of recognition of the wakeup word in the electronic device and the degree of recognition of the wakeup word in each of the one or more other electronic devices, and perform a function correspond to the command word when the electronic device has a highest priority,
wherein the degree of recognition of the wakeup word in the electronic device is obtained based on at the score of the wakeup word and the location information of the sound source in the electronic device, and
wherein the degree of recognition of the wakeup word in each of the one or more other electronic devices is obtained based on at the score of the wakeup word and the location information of the sound source each of the one or more other electronic devices.

6. The electronic device of claim 1, wherein the artificial intelligence interface is configured to determine whether the function corresponding to the command word is a function provided by the electronic device when the electronic device has the highest priority, and perform the function corresponding to the command word when the function corresponding to the command word is the function provided by the electronic device.

7. The electronic device of claim 1, wherein the artificial intelligence interface is configured to determine whether the function corresponding to the command word is a function provided by the electronic device when the electronic device has the highest priority, and transmit a command for performing the function corresponding to the command word to an electronic device having a next highest priority when the function corresponding to the command word is not the function provided by the electronic device.

8. An electronic device comprising:
an input interface configured to receive a speech input including a wakeup word and a speech input including a command word from a sound source;
a communication interface configured to communicate with one or more other electronic devices and a server; and
an artificial intelligence interface configured to obtain a degree of recognition of the wakeup word in the electronic device, receive a degree of recognition of the wakeup word in each of the one or more other electronic devices, and transmit command word information corresponding to the speech input including the command word to the server when the electronic device has a priority higher than or equal to a predetermined priority based on the degree of recognition of the wakeup word in the electronic device and the degree of recognition of the wakeup word in each of the one or more other electronic devices,
wherein the degree of recognition of the wakeup word in the electronic device is obtained based on at least one of a score of the wakeup word or location information of the sound source in the electronic device.

9. The electronic device of claim 8, wherein the artificial intelligence interface is configured to transmit the command word information to the server when the electronic device has a highest priority and perform a function corresponding to the command word when a command for performing the function corresponding to the command word is received.

10. The electronic device of claim 8, wherein the artificial intelligence interface is configured to transmit the command word information and priority information of the electronic device to the server and perform a function corresponding to the command word when a command for performing the function corresponding to the command word is received.

11. The electronic device of claim 8, wherein the artificial intelligence interface is configured to transmit the command word information to the server when the electronic device has a highest priority and perform a function corresponding to the command word when a command for performing the function corresponding to the command word is received and the function corresponding to the command word is a function provided by the electronic device.

12. A server comprising:
a communication interface configured to communicate with a plurality of electronic devices; and
a controller configured to receive command word information corresponding to a speech input of a user from one or more electronic devices, recognize a command word included in the speech input based on the command word information, obtain a function corresponding to the command word and transmit a command for performing the function corresponding to the command word to one of the one or more electronic devices.

13. The sever of claim 12, wherein the controller is configured to receive the command word information from a first electronic device, determine whether the function corresponding to the command word is a function provided by the first electronic device, and transmit a command for performing the function corresponding to the command word to the first electronic device when the function corresponding to the command word is a function provided by the first electronic device.

14. The server of claim 12, wherein the controller is configured to receive the command word information and priority information from a plurality of electronic devices, determine the function corresponding to the command word, transmit a command for performing the function corresponding to the command word when the function corresponding to the command word is a command provided by an electronic device having a highest priority, and determine whether the function corresponding to the command is a function provided by an electronic device having a next highest priority when the function corresponding to the command word is not the command provided by the electronic device having a highest priority.

15. The server of claim 12, wherein the controller is configured to receive the command word information from a first electronic device and transmit a command for performing the function corresponding to the command word to the first electronic device.
